(19) United States
(12) Patent Application Publication
(10) Pub. No.: US 2015/0292545 A1
(43) Pub. Date: Oct. 15, 2015

(54) Adjustable Torque Nut

(71) Applicant: Paul L. Cote, Lac Brome (CA)

(72) Inventor: Paul L. Cote, Lac Brome (CA)

(21) Appl. No.: 13/999,968

(22) Filed: Apr. 10, 2014

(51) Int. Cl. F16B 39/24

(52) U.S. Cl. CPC F16B 39/24

(57) ABSTRACT

An adjustable torque nut for use with a threaded member, the torque comprising an annular body having an opening therein, screwthreads located interiorly of the annular body surrounding the opening, at least one slot formed in the body at an end having the opening, and a ring member designed to fit over the end to thereby control the size of the opening and the torque.

### FIELD OF THE INVENTION

The present invention relates to an adjustable torque nut for use with a threaded member.

### BACKGROUND OF THE INVENTION

The use of screwthreads for attaching or securing articles together has been well established in the art. A screw or bolt is a type of fastener which is generally characterized by a helical ridge (external thread) wrapped around a cylinder. Screwthreads can be designed to work either by cutting a helical groove in a softer material to which it then becomes attached and is retained thereby. However, some screwthreads are designed to mate with a complimentary thread (internal thread) often in the form of a nut or other object that has the internal thread formed in it.

A majority of bolts are tightened by clockwise rotation (right hand thread) although bolts with left hand threads are used in certain specific cases.

Most screws and bolts have been made of a metallic material and in general have been formed of a steel material. Other metals have also been used including materials such as stainless steel, brass, titanium, bronze, etc. It is also known in the art to use certain types of plastic such as nylon or PTFE which can be threaded and where only moderate strength is required. These attachments have the advantage of being corrosion resistant and electrically insulating.

One problem frequently encountered is the loosening of the attachment made between a nut and a bolt. This can be caused by the passage of time, various vibrations, and the like. In order to overcome this loosening, spring washers have often been employed to exert a pressure to ensure that the nut remains in position.

It would be desirable to provide a nut for attachment to a bolt whereby the torque required to rotate the nut is adjustable so that one can design the desired parameters.

### SUMMARY OF THE INVENTION

According to one aspect of the present invention, there is provided an adjustable torque nut comprising an annular body having an opening therein, screwthreads located interiorly of the annular body surrounding the opening, at least one slot formed in the body at an end having the opening, and a ring member designed to fit over the end to thereby control the size of the opening.

According to a further aspect of the present invention, there is also provided an adjustable torque nut assembly comprising a threaded rod, a nut having an annular body, an opening extending through the annular body, screwthreads located interiorly of the annular body surrounding the opening, at least one slot formed in the body at one end thereof, and a ring member placed on the one end having the slot to exert pressure thereat.

According to a further aspect of the present invention, there is also provided a method of controlling the torque to screw/unscrew a nut and bolt, the method comprising the steps of providing a nut, the nut having an annular body with an opening therein, screw heads located interiorly of the annular body surrounding the opening, at least one slot formed in the body at one end having the opening, selecting a ring member of a desired size, and placing the ring member over the end to thereby control the size of the opening and the torque required to screw/unscrew the nut with a threaded member.

As utilized herein, the term “bolt” will include any threaded elongated member having an external thread. The term “nut” will include any device having an internal thread for attachment to a threaded member.

The nut is preferably made of a plastic material although it will be understood that other materials such as metallic materials fall within the scope of the present invention. In the case of a plastic material, any suitable plastic may be utilized; preferably the plastic material is characterized by good dimensional stability. A preferred material would be polyoxymethylene which is also known by the names acetal, polyacetal and polyformaldehyde. It is produced by many different chemical firms with slightly different formulas. Polyoxymethylene is characterized by having a high strength, hardness and rigidity. It is further characterized by having a high abrasion resistence, low coefficient of friction, high heat resistence, good electrical and dielectric properties, and a low water absorption.

The threaded member may be formed of a different or similar material as desired.

The ring member is preferably formed of polyoxymethylene.

The adjustable torque nut may be utilized in straightforward nut and bolt applications. It may also be used as part of other structures where control of the torque is important. As used herein, the term “slot” will normally refer to an arrangement wherein there are a number of different segments with space therebetween such that the segments become flexible and the size of the opening can be controlled by the torque selector ring. The ring functions to increase the pressure on the threaded member and thus increases the torque. However, it will be understood that there may indeed only be a single slot (although three are preferred) and the size of the slot can vary. For many applications, the slots will preferably extend at least 50% of the height of the nut.

### BRIEF DESCRIPTION OF THE DRAWINGS

Having thus generally described the invention, reference will be now made to the accompanying drawings illustrating embodiments thereof, in which:

FIG. 1 is a perspective view illustrating an adjustable torque nut engaged with a threaded member;

FIG. 2 is a sectional view thereof;

FIG. 3 is a side elevational view thereof;

FIG. 4 is a sectional view thereof;

FIG. 5 is an exploded view thereof;

FIG. 6 is an exploded view of a further embodiment of the adjustable torque nut and threaded element;

FIG. 7 is a perspective view illustrating the engagement of the threaded member with the adjustable torque nut;

FIG. 8 is a perspective sectional view thereof;

FIG. 9 is a side elevational view thereof;

FIG. 10 is a perspective view of the adjustable torque nut;

FIG. 11 is a side elevational view thereof; and

FIG. 12 is a perspective cross sectional view thereof.

### DETAILED DESCRIPTION OF THE INVENTION

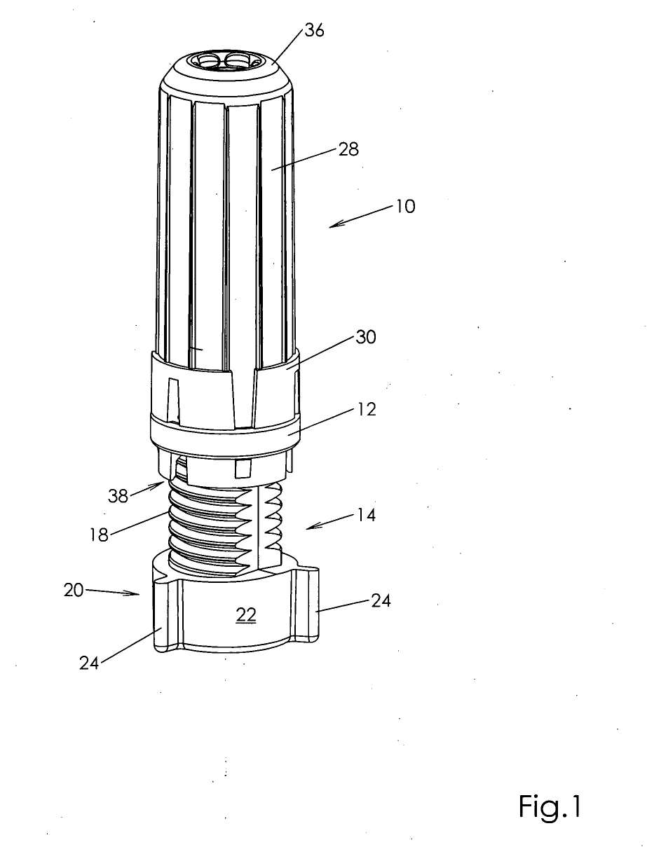

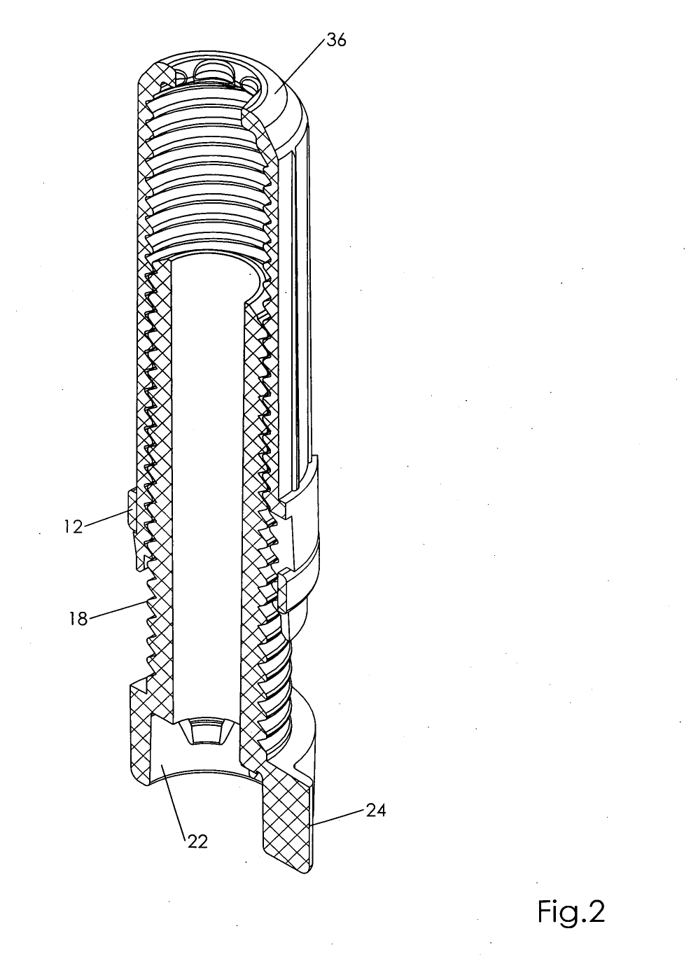

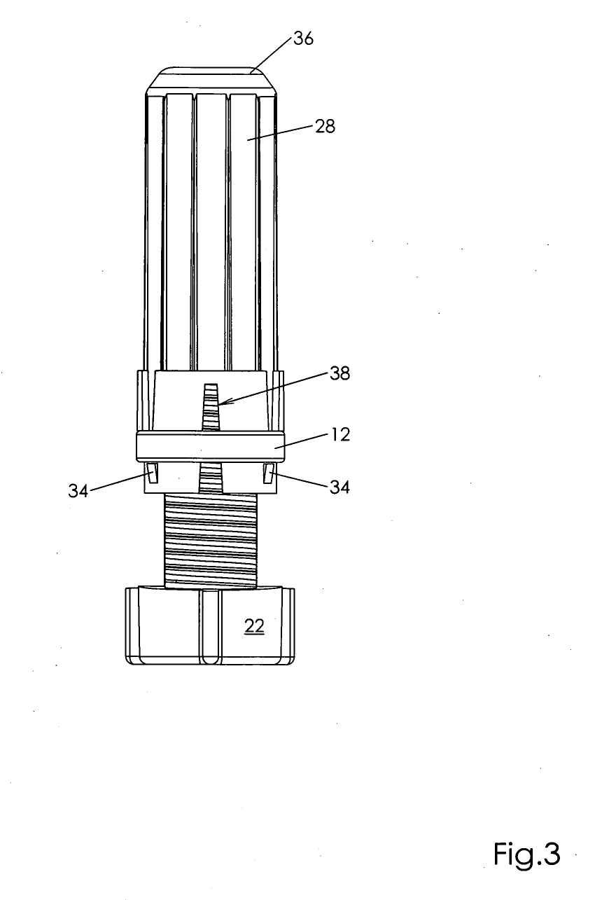

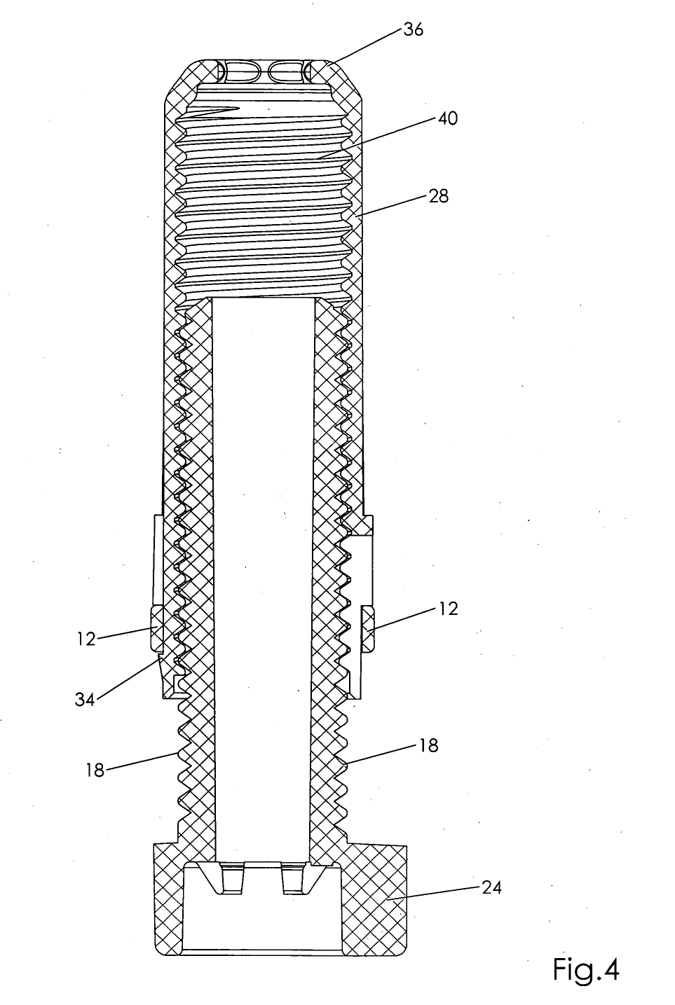

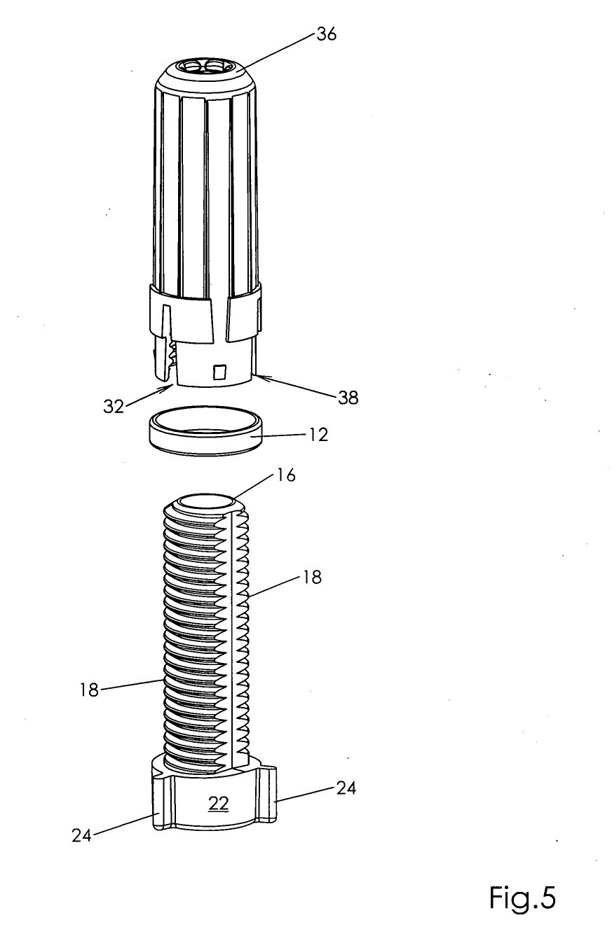

Referring to the drawings in greater detail and by reference characters thereto, there is illustrated in FIGS. 1 to 5 a first embodiment of a torque nut and threaded member. Thus, as may be seen, there is provided a nut 10, a torque selector ring 12, and threaded member 14.

Threaded member 14 comprises a substantially cylindrical shaft 16 having external threads 18 formed thereon in a known manner. A gripping head generally designated by reference numeral 20 is located at one end of threaded member 14 and comprises a body portion 22 having flanges 24 extending outwardly therefrom to assist in gripping body portion 22. Naturally, any known type of gripping head 20 may be employed including those designed to be utilized with wrenchs or screwdrivers or the like.

Adjustable torque nut 10 includes a cylindrical body portion 28. A reinforcing portion 30 is located on the exterior of cylindrical body 28. Adjustable torque nut 10 includes an inlet end generally designated by reference numeral 32. Inlet end 32 is designed to receive the end of threaded member 14 and mate with internal threads 40.

On the exterior of reinforced portion 30 there are provided a plurality of tapered lugs 34. Tapered lugs 34 are designed to help in placement of torque selector ring 12 thereon and for retention purposes. Naturally, other retention means could be utilized. At the other end of adjustable torque nut 10 there is provided an inwardly extending wall 36 to limit the depth of movement of threaded member 14.

A plurality of slots 38 are formed at inlet end 32 to provide a certain flexibility to the adjustable torque nut 10. The selection of a certain size of torque selector ring 12 will control the size of the inner diameter of adjustable torque nut 10 and thereby control the torque.

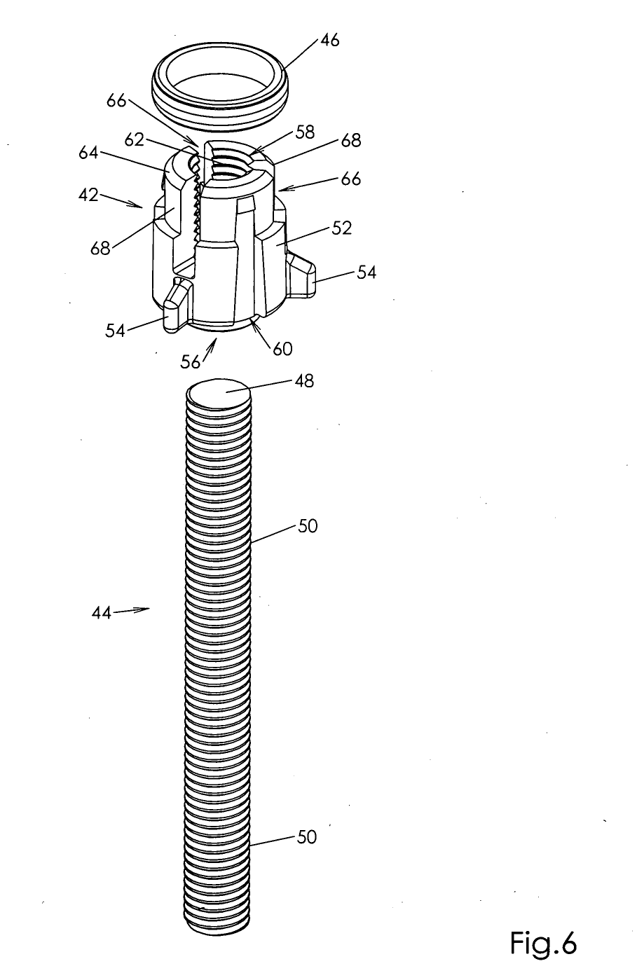

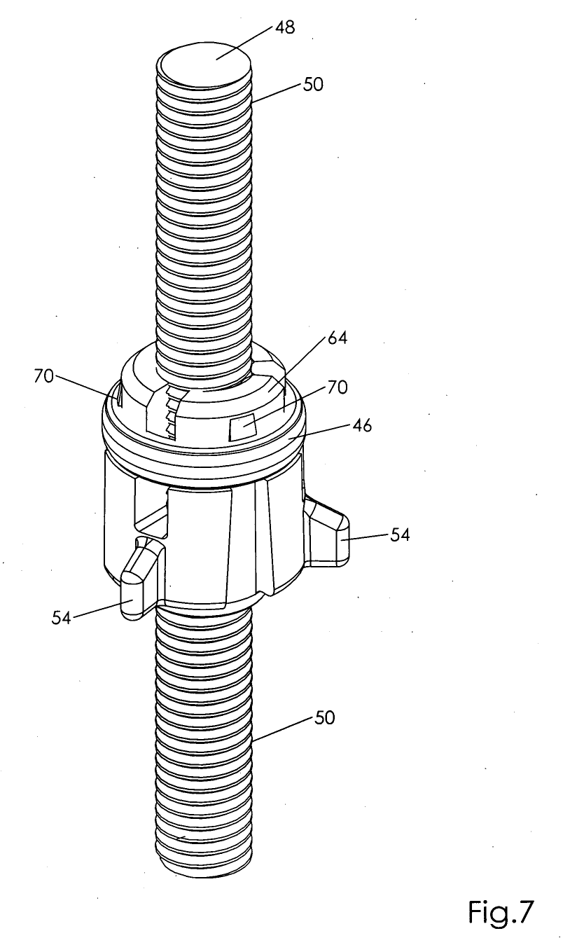

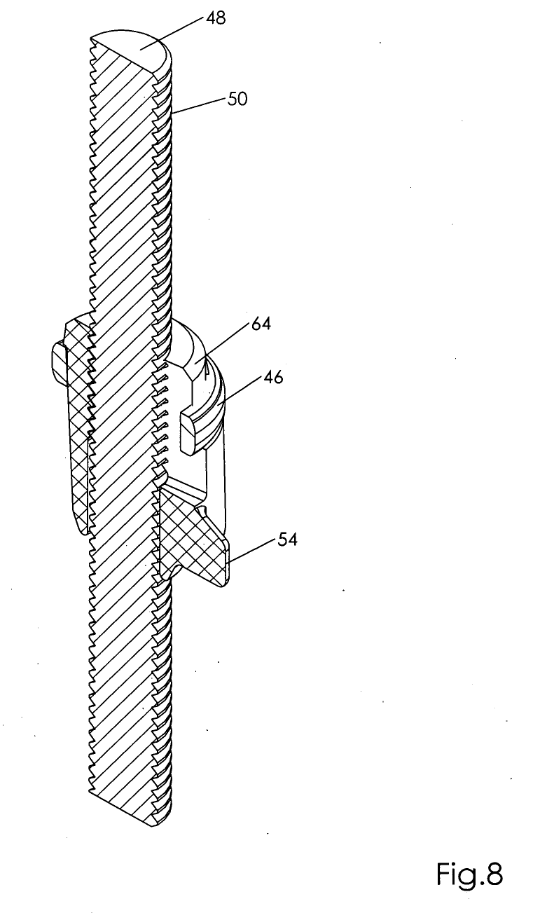

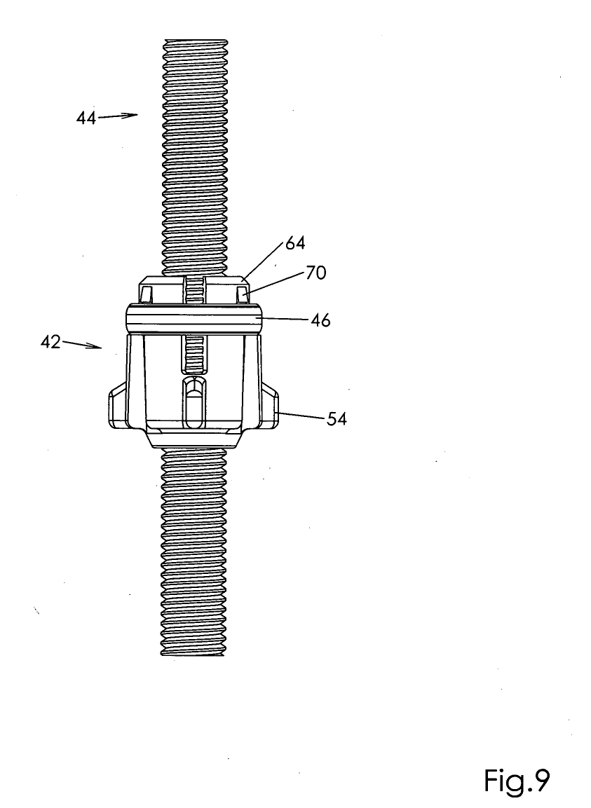

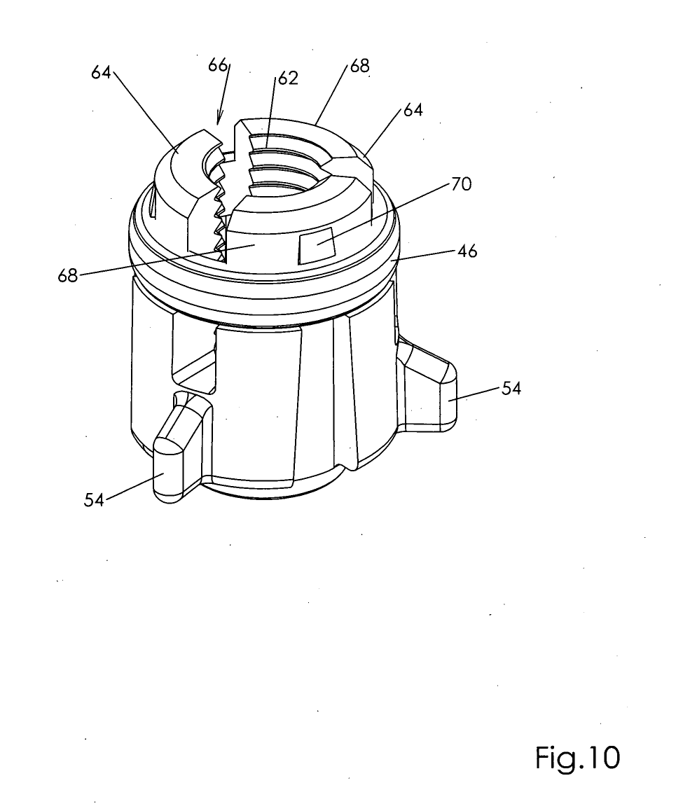

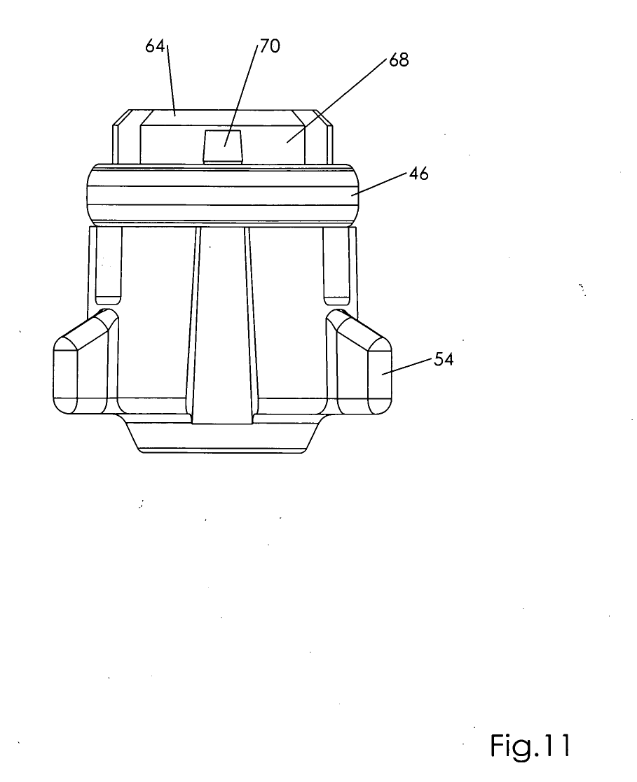

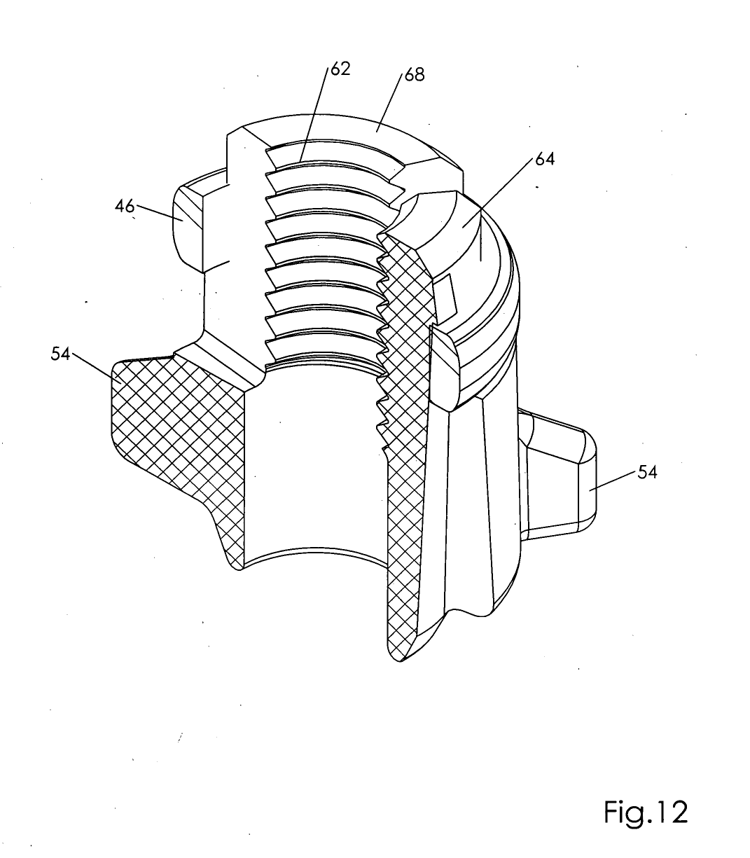

Reference will now be made to the embodiment illustrated in FIGS. 6 to 12. In this embodiment, there is provided a nut generally designated by reference numeral 42, a threaded member generally designated by reference numeral 44, and a torque selector ring 46.

Threaded member 44 is in the form of a solid rod 48 having external threads 50 formed thereon.

Nut 42 has a body 52 having an inlet end 56 and an outlet end 58. Adjacent inlet end 56, body 52 has flanges 54 which aid in the hand gripping of the nut for turning the same. Naturally, other configurations can be arranged.

Body 52 has a plurality of grooves 60 formed therein. Nut 42 includes internal threads 62 which are formed at least adjacent outlet end 58.

It will be noted that adjacent outlet end 58, the nut is provided with a tapered shoulder 64 to assist in the placement of torque selector ring 46 thereabout. Also adjacent outlet end 58, there are provided a plurality of slots 66 to divide the body into somewhat flexible segments 68.

The torque selector ring 46 is selected to provide a given torque when nut 42 is screwthreadably engaged with threaded member 44. Thus, the smaller the internal diameter of torque selector ring 46, the tighter it will grip and move segments 68 inwardly to provide a higher torque. As in the previous embodiment, tapered lugs 70 assist in the retention of torque selector ring 46.

It will be understood that the embodiments are for purposes of illustration only and that changes and modifications may be made thereto without departing from the spirit and scope of the invention.

I claim:

1. An adjustable torque nut comprising:
an annular body having an opening therein;
screwthreads located interiorly of said annular body surrounding said opening;
at least one slot formed in said body at an end having said opening; and
a ring member designed to fit over said end to thereby control the size of said opening.

2. The adjustable torque nut of claim 1 wherein three slots are formed in said body at said end thereof.

3. The adjustable torque nut of claim 1 wherein said opening extends through said annular body to provide first and second ends, one of said ends being an inlet end to receive a threaded member, the other of said ends being an outlet end through which said threaded member passes, said slots being located at said outlet end.

4. The adjustable torque nut of claim 3 wherein said outlet end has a tapered surface to allow for easy placement of said ring member.

5. The adjustable torque nut of claim 1 wherein said annular body is formed of a plastic material.

6. The adjustable torque nut of claim 5 wherein said ring member is formed of a plastic material.

7. The adjustable torque nut of claim 4 wherein said outlet end includes means to retain said ring member in position.

8. The adjustable torque nut of claim 6 wherein said plastic material of said ring member and said annular body is polyoxymethylene.

9. An adjustable torque nut assembly comprising:
a threaded rod;
a nut having an annular body, an opening extending through said annular body;
screwthreads located interiorly of said annular body surrounding said opening;
at least one slot formed in said body at one end thereof; and
a ring member placed on said one end having said slot to exert pressure thereat.

10. The adjustable torque nut assembly of claim 9 wherein three slots are formed in said body at said end thereof.

11. The adjustable torque nut assembly of claim 9 wherein said opening extends through said annular body to provide first and second ends, one of said ends being an inlet end to receive a threaded member, the other of said ends being an outlet end through which said threaded member passes, said slots being located at said outlet end.

12. The adjustable torque nut assembly of claim 11 wherein said outlet end has a tapered surface to allow for easy placement of said ring member.

13. The adjustable torque nut assembly of claim 9 wherein said annular body is formed of a plastic material.

14. The adjustable torque nut assembly of claim 13 wherein said ring member is formed of a plastic material.

15. The adjustable torque nut assembly of claim 14 wherein said plastic material of said ring member and said annular body is polyoxymethylene.

16. A method of controlling the torque to screw/unscrew a nut and bolt, the method comprising the steps of providing a nut, said nut having an annular body with an opening therein, screw heads located interiorly of said annular body surrounding said opening, at least one slot formed in said body at one end having said opening;
selecting a ring member of a desired size; and
placing said ring member over said end to thereby control the size of said opening and the torque required to screw/unscrew said nut with a threaded member.
